(19) United States
(12) Patent Application Publication
(10) Pub. No.: US 2017/0346661 A1
(43) Pub. Date: Nov. 30, 2017

(54) ETHERNET MAGNETICS INTEGRATION

(71) Applicants: Michael McCarthy, Co Limerick (LI); David Bolognia, Charlestown, MA (US); Oisin Aodh O. Cuanachain, Baile Atha Cliath (IE); Check F. Lee, Bedford, MA (US); Miguel Angel Fernandez Robayna, Cobena (ES)

(72) Inventors: Michael McCarthy, Co Limerick (LI); David Bolognia, Charlestown, MA (US); Oisin Aodh O. Cuanachain, Baile Atha Cliath (IE); Check F. Lee, Bedford, MA (US); Miguel Angel Fernandez Robayna, Cobena (ES)

(21) Appl. No.: 15/164,267

(22) Filed: May 25, 2016

(51) Int. Cl. H04L 25/02; H04L 25/03

(52) U.S. Cl. CPC H04L 25/0278; H04L 25/03019

(57) ABSTRACT

An integrated circuit is disclosed and includes an Ethernet physical layer (PHY) with a plurality of communication channels. The communication channels coupled to a corresponding plurality of terminals. The integrated circuit further includes a plurality of electrical isolation circuits and a compensation circuit. At least one of the plurality of electrical isolation circuits is coupled to a corresponding one of the plurality of communication channels and electrically isolates the PHY from a corresponding one of the plurality of terminals. The compensation circuit is configured to compensate for at least one of baseline wander and parameter drift associated with at least one of the plurality of isolation circuits. The PHY and the plurality of isolation circuits are integrated on a single substrate.

### BACKGROUND

In an Ethernet communication system, the IEEE 802.3 standard requires that electrical isolation be provided between an Ethernet physical layer circuit—usually referred to as an “Ethernet PHY”—and an Ethernet port (e.g., a medium-dependent interface (MDI)), which provides a physical and electrical connection to a cabling medium (e.g., Cat5 cable with RJ45 connectors).

### SUMMARY

One approach can provide such isolation by a transformer or a magnetic circuit between each channel of the Ethernet PHY and the Ethernet port. For example, an Ethernet PHY and magnetic circuits can be packaged separately and mounted on a circuit board, along with the Ethernet port, resulting in a large package. Since the magnetics are typically hand-wound, there can be high variability and poor tolerance in their impedances, resulting in poor impedance matching with the Ethernet PHY, poor mode conversion performance, and poor noise immunity. Some approaches can integrate the magnetic circuits with the Ethernet port to provide some circuit board area savings, but do not solve the other issues.

Therefore, the present inventors have recognized, among other things, that a need exists for circuits, systems, and method to integrate magnetic circuits with an Ethernet PHY to provide increased noise immunity, better impedance matching between the magnetic circuits and the Ethernet PHY, and improved common-mode rejection ratio (CMRR).

Embodiments of the present disclosure can provide an integrated circuit that can include, on the same substrate, an Ethernet PHY coupled to a plurality of magnetic circuits. The integrated circuit may also include electrostatic discharge (ESD) protection circuits between the Ethernet PHY and the magnetic circuits, and electromagnetic interference (EMI) filtering circuits between the magnetic circuits and terminals that couple to an external Ethernet port. The integrated circuit may further include a compensation and calibration circuit that can be coupled to the Ethernet PHY, the magnetic circuit, the ESD protection circuits, and the EMI filtering circuits.

In an example, an integrated circuit can include an Ethernet physical layer (PHY) with a plurality of communication channels. The communication channels can be coupled to a corresponding plurality of terminals. The integrated circuit can further include a plurality of electrical isolation circuits and a compensation circuit. At least one of the plurality of electrical isolation circuits can be coupled to a corresponding one of the plurality of communication channels and can electrically isolate the PHY from a corresponding one of the plurality of terminals. The compensation circuit can be configured to compensate for at least one of baseline wander and parameter drift such as can be associated with at least one of the plurality of isolation circuits. The and the plurality of isolation circuits are integrated on a single substrate.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 illustrates a block diagram of an integrated circuit according to an embodiment of the present disclosure.

FIGS. 2-4 illustrate magnetic circuits according to some embodiments of the present disclosure.

FIG. 5 illustrates a compensation circuit in accordance with an embodiment of the present disclosure.

FIG. 6 illustrates a flow diagram of an example method for communicating data, in accordance with an embodiment.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

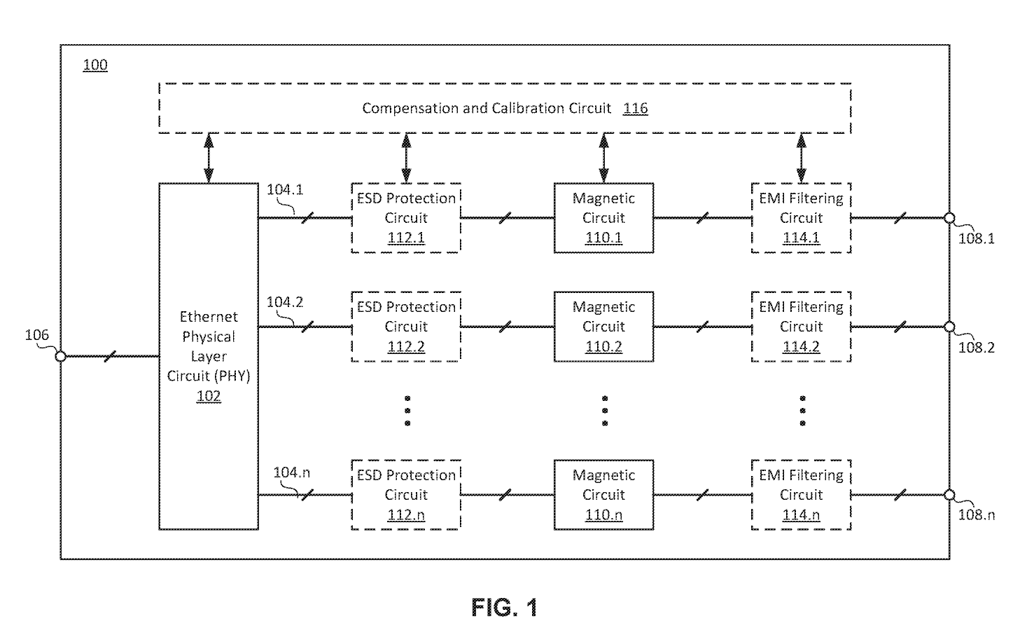

FIG. 1 illustrates a block diagram of an integrated circuit 100 according to an embodiment of the present disclosure. The integrated circuit 100 may include an Ethernet physical layer circuit (Ethernet PHY) 102 having a plurality of channels 104.1-104.n such as to communicate data between a terminal 106 and terminals 108.1-1.08.n. Each of the channels 104.1-104.n may be either a receive channel or a transmit channel. For example, a 10/100 Ethernet system can include two channels (i.e., n=2), one being a receive channel and the other a transmit channel. A 1000 Base-T Ethernet system can include four channels (i.e., n=4).

As shown in FIG. 1, a plurality of magnetic circuits 110.1-110.n may be provided in the respective channels 104.1-104.n, such as between the Ethernet PRY 102 and the terminals 108.1-108.n, which may be coupled to an external Ethernet port (not shown). Through semiconductor fabrication techniques, the magnetic circuits 110.1-110.n may be fabricated to be substantially identical, such as with perfect winding center tap symmetry and calibrated to match the impedance of drivers of the Ethernet PHY 102. As such, mode conversion performance may be improved, common-mode rejection ratio (CMRR) may be increased, circuit efficiency may be improved, and electromagnetic interference (EMI) emissions may be reduced. Moreover, integrating the magnetic circuits 110.1-110.n on the same substrate as the Ethernet PHY 102 may minimize or shorten connections between the magnetic circuits 110.1-110.n and the Ethernet 102. Consequently, parasitic serial resistance, inductance, and capacitance may be minimized and noise immunity may be increased.

The integrated circuit 100 may also include electrostatic discharge (ESD) protection circuits 112.1-112.n and EMI filtering circuits 114.1-114.n in the respective channels 104.1.-104.n. For example, the ESD circuits 112.1-112.n may be provided between the Ethernet PHY 102 and the corresponding magnetic circuits 110.1-110.n. The EMI filtering circuits 114.1-11.4.n may be provided between the corresponding magnetic circuits 110.1-110.n and the terminals 108.1-108.n to further reduce EMI emissions.

The integrated circuit 100 may further include a compensation and calibration circuit 116. The compensation and calibration circuit 116 may be coupled to one or more of the Ethernet PHY 102, the magnetic circuits 110.1-11.0.n, the ESD circuits 112.1-112.n, and the EMI filtering circuits 114.1-111.4.n. The compensation and calibration circuit 116 may include, fur example, circuitry to compensate for baseline wander that may result from the use of the relatively smaller integrated magnetic circuits 110.1-110.n. The compensation and calibration circuit 116 may also include circuitry to compensate for parameter drift in the Ethernet PHY 102, the magnetic circuits 110.1-110.n, the ESD circuits 112.1-112.n, and/or the EMI filtering circuits 114.1-114.n such as over the lifetime of the integrated circuit 100. During production of the integrated circuit 100, the compensation and calibration circuit 116 may calibrate one or more compensation parameters, such as one or more loop gains, one or more integration constants, etc., such as by trimming one or more resistances, one or more capacitances, and/or one or more inductances. The integrated circuit 100 may be fabricated as a laminate grid array (LGA) or a ball grid array (BGA) (other fabrication techniques can be used as well, such as custom lead frame).

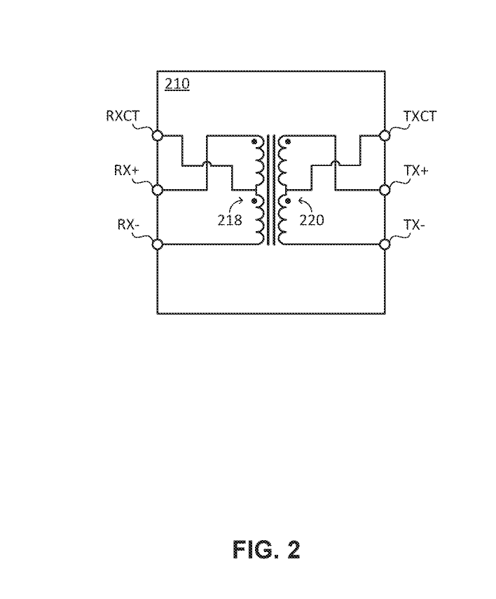

FIG. 2 illustrates a magnetic circuit 210 according to an embodiment of the present disclosure. The magnetic circuit 210 may be an example of one or more of the magnetic circuits 110.1-110.n of FIG. 1. The magnetic circuit 210 can include a first winding 218 and a second winding 220, providing an electrical isolation barrier such as required by the IEEE 802.3 standard. The magnetic circuit 210 may receive differential data across a positive (+) terminal and a negative (−) terminal on the primary side and transmit the differential data over the isolation barrier to a positive terminal and a negative terminal on the secondary side. The transmission of the differential data may be accomplished in the opposite direction, e.g., from the secondary side to the primary side. Each of the first winding 218 and second winding 220 may have a center tap (CT) such as to allow for biasing of the differential data, for example. The turns ratio between the first winding 218 and the second winding 220 may be set to unity.

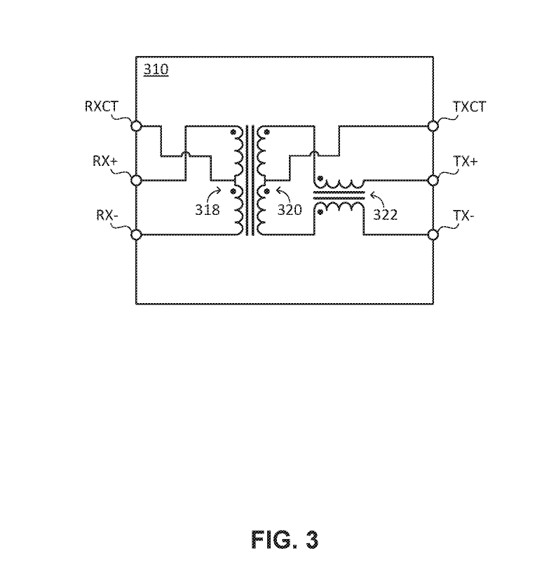

FIG. 3 illustrates a magnetic circuit 310 according to an embodiment of the present disclosure. The magnetic circuit 310 may be an example of one or more of the magnetic circuits 110.1-110.n of FIG. 1. The magnetic circuit 310 can include a first winding 318 and a second winding 320, such as can provide an electrical isolation barrier such as required by the IEEE 802.3 standard. The magnetic circuit 310 may also include a common-mode (CM) choke 322 such as can be connected to the second winding 320 such as shown in FIG. 3. The magnetic circuit 310 may receive differential data across a positive (+) terminal and a negative (−) terminal on the primary side and transmit the differential data over the isolation barrier, through the CM choke 322, to a positive terminal and a negative terminal on the secondary side. The transmission of the differential data may be accomplished in the opposite direction, e.g., from the secondary side to the primary side. Each of the first winding 318 and second winding 320 may have a center tap (CT) such as to allow for biasing of the differential data, for example. The turns ratio between the first winding 318 and the second winding 320 may be set to unity. The CM choke 322 may help reduce susceptibility to external EMI such as during reception of the differential data.

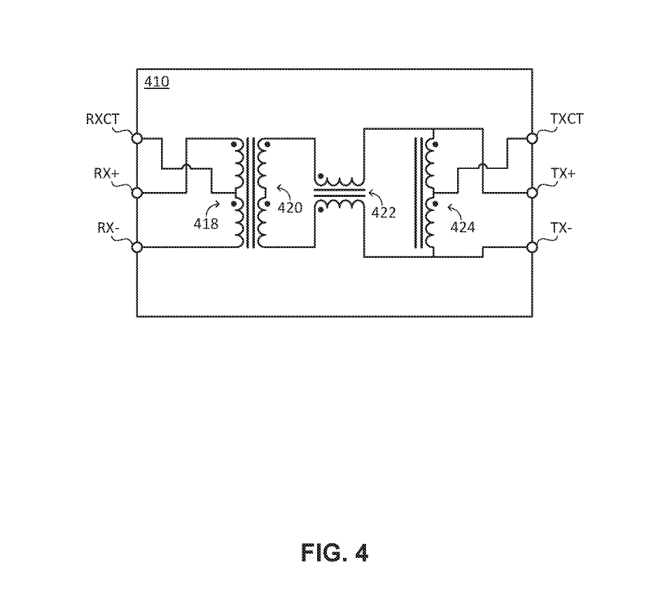

FIG. 4 illustrates a magnetic circuit 410 according to an embodiment of the present disclosure. The magnetic circuit 410 may be an example of the magnetic circuits 110.1-110.n of FIG. 1. The magnetic circuit 410 includes a first winding 418 and a second winding 420, providing an electrical isolation barrier such as required by the IEEE 802.3 standard. The magnetic circuit 410 may also include a common-mode (CM) choke 422 connected to the second winding 420 and a third winding 424 as shown in FIG. 4. The magnetic circuit may receive differential data across a positive (+) terminal and a negative (−) terminal on the primary side and transmit the differential data over the isolation barrier, through the CM choke 422, to a positive terminal and a negative terminal on the secondary side. The transmission of the differential data may be accomplished in the opposite direction, e.g., from the secondary side to the primary side. Each of the first winding 418 and third winding 424 may have a center tap (CT) such as to allow for EMI reduction, Power over Ethernet (PoE) applications, and/or biasing of the differential data, for example. The turns ratio between the first winding 418, the second winding 420, and the third winding 424 may be set to unity. The CM choke 422 may reduce susceptibility to external EMI such as during reception of the differential data.

In an example, PoE applications can be achieved using the secondary center tap connection. More specifically, the secondary winding of a transformer can be used to provide DC power (e.g., 24V/48V) to a remote end such as by connecting a DC voltage source between two center taps.

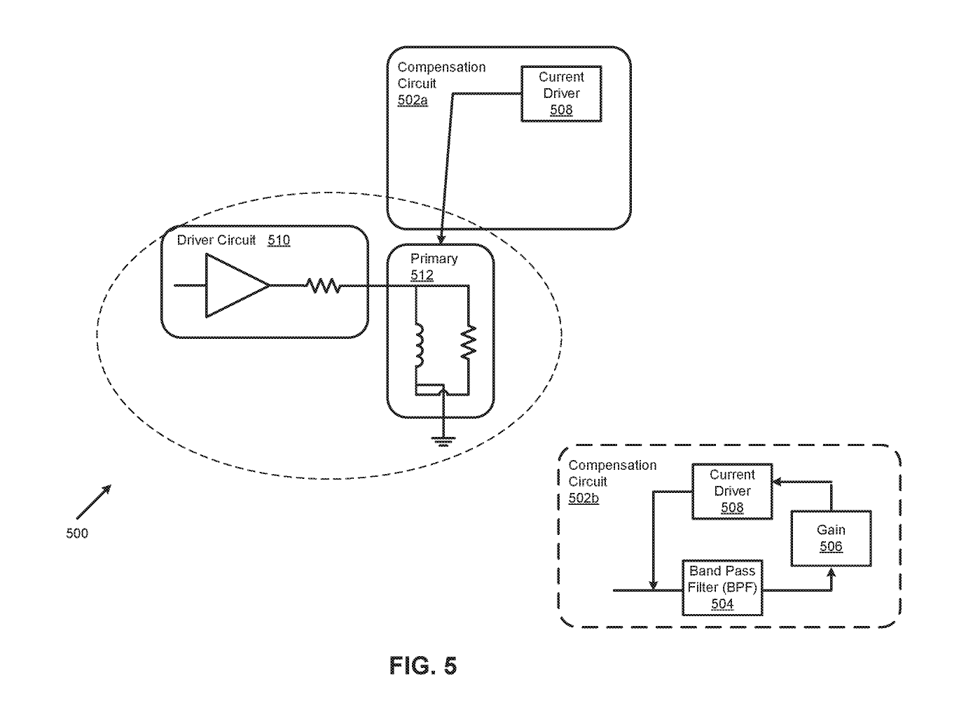

FIG. 5 illustrates a compensation circuit in accordance with an embodiment of the present disclosure. Referring to FIG. 5, the depicted embodiment of the compensation circuit 502a is an open-loop compensation circuit which can be coupled to the primary side 512 of a transformer 500. The transformer 500 may include a driver circuit 510. In an example, the transformer 500 can be coupled to a communication circuit, and the driver circuit 510 can be part of the communication circuit (not shown in FIG. 5).

In the illustrated example in FIG. 5, the compensation circuit 502a is an open-loop compensation circuit configured to generate a current to compensate for the baseline wander experienced at the transformer 500. That is, the compensation circuit 502 can be configured to inject a current into the primary side 512 of the transformer 500 in an amount that compensates for any energy lost due to the inductive nature of the transformer 500. The relationship between inductance, voltage and current may be represented by the following equation:

$$V ( t ) = L \frac{di ( t )}{dt}$$

where v(t) is the voltage at the primary of the transformer, i(t) is the current in the primary of the transformer, and L is the inductance in the equivalent circuit of the primary side 512 of the transformer 500. In this regard, to eliminate baseline wander, the compensation circuit 502 may produce a constant or substantially constant v(t). To produce a constant v(t), a current i(t) may be needed as follows:

$$\int di ( t ) = \frac{V}{L} \int dt$$

$$i ( t ) = \frac{V}{L} [ t - t 0 ] = \frac{V}{L} Δ T$$

Thus, the required current may be a current ramp proportional to time, with a slope of V/L.

In another example, the compensation circuit can be a closed-loop compensation circuit, such as circuit 502b. In this example implementation, the compensation circuit 502b can include a band-pass filter (BPF) 504, a gain stage 506, and a current driver 508. The compensation circuit 502 may be connected to the primary side 512 of a transformer 500, being driven by an uncompensated or insufficiently compensated communication circuit. The illustrated loop of the compensation circuit (e.g., components 504, 506, and 508) may result in a current, such as, e.g., a ramp current, being provided to the primary side 512 to compensate for the uncompensated or insufficiently compensated communication circuit. Additionally, the loop gain of compensation circuit 502b can be associated with internal capacitance, and variations in the inductance can be compensated using, e.g., adjustments in the internal capacitance.

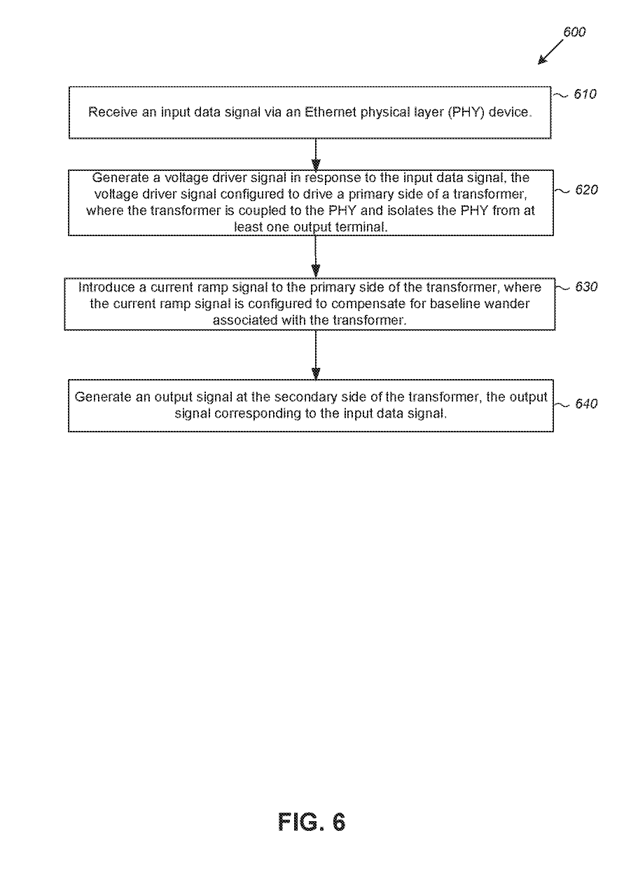

FIG. 6 illustrates a flow diagram of an example of a method for communicating data, in accordance with an embodiment. Referring to FIGS. 1 and 6, the example of method 600 for communication of data may be performed using one or more processors within an integrated circuit (e.g., 100). The one or more processors may include an Ethernet physical layer (PHY) device (e.g., 102) coupled to a transformer (e.g., 110.1 110.n), where the transformer and the PRY are integrated within the circuit 100. At 610, the PHY can receive an input data signal. (e.g., an Ethernet signal via the input port 106). At 620, the PHY (e.g., a driver circuit within the PHY) can generate a voltage driver signal in response to the input data signal. The voltage driver signal can be configured to drive a primary side of the transformer (e.g., 218, 318, or 418). The transformer (110) can be configured to isolate the PHY from at least one output terminal (e.g., 108.1-108.n). At 630, a current ramp signal can be introduced to the primary side of the transformer (e.g., the compensation circuit 116 or 502 can generate the current ramp signal, such as the output of current driver 508). The current ramp signal can be configured to compensate for baseline wander associated with the transformer (110). At 640, an output signal can be generated at the secondary side (e.g., 220, 320, or 420) of the transformer, the output signal corresponding to the input data signal and can be communicated outside of the circuit 100 via the output terminals 108.

### VARIOUS NOTES & EXAMPLES

Example 1 can include an integrated circuit, which can comprise: an Ethernet physical layer (PHY) that can include a plurality of communication channels, the communication channels can be coupled to a corresponding plurality of terminals; a plurality of isolation circuits, wherein at least one of the plurality of electrical isolation circuits can be coupled to a corresponding one of the plurality of communication channels and can electrically isolate the PHY from a corresponding one of the plurality of terminals; and a compensation circuit that can be configured to compensate for at least one of baseline wander and parameter drift associated with at least one of the plurality of isolation circuits.

In Example 2, the subject matter of Example 1 optionally includes wherein the PHY and the plurality of isolation circuits are integrated on a single substrate.

In Example 3, the subject matter of any one or more of Examples 1-2 optionally include wherein at least one of the plurality of isolation circuits includes an electrical transformer.

In Example 4, the subject matter of any one or more of Examples 1-3 optionally include wherein at least one of the plurality of isolation circuits includes a magnetic circuit.

In Example 5, the subject matter of any one or more of Examples 1-4 optionally include wherein at least one of the plurality of isolation circuits is configured to match an impedance of a driver circuit associated with the PHY.

In Example 6, the subject matter of any one or more of Examples 1-5optionally include wherein the terminals are configured for connection to an Ethernet port.

In Example 7, the subject matter of any one or more of Examples 1-6 optionally include wherein the PHY is one of: a 10/100 Ethernet PHY with at least two communication channels; and a 1000 Base-T Ethernet PHY with at least four communication channels.

In Example 8, the subject matter of any one or more of Examples 1-7 optionally include wherein at least one of the plurality of isolation circuits includes an electrical transformer with a primary side and a secondary side, the primary side electrically coupled to the compensation circuit.

In Example 9, the subject matter of Example 8 optionally includes wherein the compensation circuit is further configured to inject a current into the primary side of the electrical transformer to compensate for at least one of the baseline wander and the parameter drift.

In Example 10, the subject matter of Example 9 optionally includes wherein the compensation circuit comprises a current driver configured to generate the current injected into the primary side of the electrical transformer.

In Example 11, the subject matter of any one or more of Examples 1-10 optionally include wherein the compensation circuit is configured to adjust at least one of resistance, capacitance and inductance associated with the at least one of the plurality of electrical isolation circuits, to compensate for the parameter drift.

Example 12 is a single-substrate integrated circuit, comprising: an Ethernet physical layer (PHY) including a plurality of communication channels and at least one driver circuit; and at least one isolation circuit coupled to the PHY, the at least one isolation circuit configured to: match an impedance of the at least one driver circuit; and electrically isolate the PHY from at least one of a plurality of connection terminals.

In Example 13, the subject matter of Example 12 optionally includes at least one electrostatic discharge (ESD) circuit coupled between the PHY and the at least one isolation circuit, the ESD circuit configured to suppress transient voltage in the integrated circuit.

In Example 14, the subject matter of any one or more of Examples 12-13 optionally include at least one electromagnetic interference (EMI) circuit coupled between the at least one isolation circuit and the at least one of a plurality of connection terminals, the EMI circuit configured to suppress electromagnetic interference.

In Example 15, the subject matter of any one or more of Examples 12-14 optionally include wherein the PHY and the at least one isolation circuit are integrated on single substrate as a laminate grid array (LGA) or a ball grid array (BGA).

In Example 16, the subject matter of any one or more of Examples 12-15 optionally include wherein the least one isolation circuit is configured according to an IEEE 802.3 standard.

Example 17 is a method for communication of data, the method comprising: performing using one or more processors within an integrated circuit, said one or more processors comprising an Ethernet physical layer (PHY) device and a transformer: receiving an input data signal via the PHY; generating a voltage driver signal in response to the input data signal, the voltage driver signal configured to drive a primary side of the transformer, wherein the transformer isolates the PHY from at least one output terminal; introducing a current ramp signal to the primary side of the transformer, wherein the current ramp signal is configured to compensate for baseline wander associated with the transformer; and generating an output signal at the secondary side of the transformer; the output signal corresponding to the input data signal.

In Example 18, the subject matter of Example 17 optionally includes filtering the output signal using an electromagnetic interference (EMI) circuit; and communicating the filtered output signal at the at least one output terminal.

In Example 19, the subject matter of any one or more of Examples 17-18 optionally include using the transformer, matching an impedance of a driver circuit generating the voltage driver signal.

In Example 20, the subject matter of any one or more of Examples 17-19 optionally include wherein the one or more processors further comprise a compensation circuit configured to generate the current ramp signal.

Each of the non-limiting examples described herein can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An integrated circuit, comprising:
an Ethernet physical layer (PHY) including a communication channel, the communication channel coupled to a corresponding terminal;
an electrical isolation circuit, wherein the electrical isolation circuit includes an electrical transformer with a first side connected with the PHY and a second side connected with the terminal, wherein the electrical transformer is configured to receive a differential signal from the PHY at the first side for transmission to the terminal via the second side, the electrical transformer electrically isolating the PHY from the terminal; and
a compensation circuit configured to compensate for at least one of baseline wander or parameter drift associated with the isolation circuit, wherein the compensation circuit is further configured to inject a current into the first side of the electrical transformer, opposite the second side that receives the differential signal for transmission to the terminal, to compensate for at least one of the baseline wander or the parameter drift.

2. The circuit of claim 1, wherein the PHY and the isolation circuit are integrated on a single substrate.

3. The circuit of claim 1, wherein the compensation circuit comprises a filter stage and a current driver stage connected in a closed-loop configuration, the compensation circuit configured to generate the current injected at the first side based on the received differential signal.

4. The circuit of claim 1, wherein the electrical transformer is configured to receive a second differential signal at the second side from the terminal, the second differential signal for transmission to the PHY via the first side.

5. The circuit of claim 1, wherein the isolation circuit is configured to match an impedance of a driver circuit associated with the PHY.

6. The circuit of claim 1, wherein the terminal is configured for connection to an Ethernet port.

7. The circuit of claim 1, wherein the PHY is one of:
a 10/100 Ethernet PHY with at least two communication channels; and
a 1000 Base-T Ethernet PHY with at least four communication channels.

8. The circuit of claim 1, wherein the compensation circuit is configured to generate the current for injecting into the primary side without requiring use of a sampled representation of the differential signal.

9. The circuit of claim 1, wherein the compensation circuit is further configured to inject the current into the first side of the electrical transformer, subsequent to receiving the differential signal at the transformer, or prior to transmitting a second differential signal from the transformer.

10. The circuit of claim 9, wherein the second differential signal is received from the terminal at the second side of the transformer, for transmission to the PHY via the first side of the transformer.

11. The circuit of claim 1, wherein the compensation circuit is configured to adjust at least one of resistance, capacitance and inductance associated with the electrical isolation circuit, to compensate for the parameter drift.

12. A single-substrate integrated circuit, comprising:
an Ethernet physical layer (PHY) including a plurality of communication channels and at least one driver circuit; and
at least one isolation circuit coupled to the PHY the at least one isolation circuit configured to:
match an impedance of the at least one driver circuit; and
electrically isolate the PHY from at least one of a plurality of connection terminals; and
a compensation circuit, the at least one compensation circuit comprising a filter stage and a current driver stage connected in a closed-loop configuration, wherein the compensation circuit is configured to generate a current ramp signal for the at least one isolation circuit to compensate for at least one of baseline wander or parameter drift associated with the at least one isolation circuit.

13. The circuit of claim 12, further comprising:
at least one electrostatic discharge (ESD) circuit coupled between the PHY and the at least one isolation circuit, the ESD circuit configured to suppress transient voltage in the integrated circuit.

14. The circuit of claim 12, further comprising:
at least one electromagnetic interference (EMI) circuit coupled between the at least one isolation circuit and the at least one of a plurality of connection terminals, the EMI circuit configured to suppress electromagnetic interference.

15. The circuit of claim 12, wherein the PHY and the at least one isolation circuit are integrated on single substrate as a laminate grid array (LGA) or a ball grid array (BGA).

16. The circuit of claim 12, wherein the least one isolation circuit is configured according to an IEEE 802.3 standard.

17. A method for communication of data, the method comprising:
performing using one or more processors within an integrated circuit, said one or more processors comprising an Ethernet physical layer (PHY) device coupled to a transformer:
receiving via the PHY, an input data signal at a first side of the transformer, for communication to a second side of the transformer;
generating a voltage driver signal in response to the input data signal, the voltage driver signal configured to drive a first side of the transformer receiving the input data signal, wherein the transformer isolates the PHY from at least one output terminal;
introducing a current ramp signal to the first side of the transformer that receives the input data signal, wherein the current ramp signal is configured to compensate for baseline wander or parameter drift associated with the transformer; and.
generating an output signal at the second side of the transformer for communication to an output terminal, the output signal corresponding to the input data signal.

18. The method according to claim 17, further comprising:
filtering the output signal using an electromagnetic interference (EMI) circuit; and
communicating the filtered output signal at the at least one output terminal.

19. The method according to claim 17, further comprising:
using the transformer, matching an impedance of a driver circuit generating the voltage driver signal.

20. The method according to claim 17, wherein the one or more processors further comprise a compensation circuit configured to generate the current ramp signal.

21. An integrated circuit, comprising:
an Ethernet physical layer (PHY) including a plurality of communication channels, the communication channels coupled to a corresponding plurality of terminals;
a plurality of electrical isolation circuits, wherein:
at least one of the plurality of electrical isolation circuits is coupled to a corresponding one of the plurality of communication channels and electrically isolates the PHY from a corresponding one of the plurality of terminals;
the PHY and the plurality of isolation circuits are integrated on a single substrate; and
at least one of the plurality of isolation circuits includes a magnetic circuit; and
a compensation circuit comprising a filter stage and a current driver stage connected in a closed-loop configuration, wherein the compensation circuit is configured to compensate for at least one of baseline wander or parameter drift associated with at least one of the plurality of isolation circuits.
